(19) United States
(12) Patent Application Publication
(10) Pub. No.: US 2007/0041374 A1
(43) Pub. Date: Feb. 22, 2007

(54) Reset to a default state on a switch fabric

(76) Inventors: Randeep Kapoor, Gilbert, AZ (US); Mo Rooholamini, Gilbert, AZ (US)

Correspondence Address: INTEL CORPORATION;C/O INTELLEVATE, LLC, P.O. BOX 52050, MINNEAPOLIS, MN, 55402, US

(21) Appl. No.: 11/206,548

(22) Filed: Aug. 17, 2005

(51) Int. Cl. H04L 12/50

(52) U.S. Cl. 370/386

(57) ABSTRACT

In a node coupled to a switch fabric a method that includes generating a data packet including content to indicate a reset request to reset a node coupled to the switch fabric to a default state. Broadcasting the data packet to at least one other node coupled to the switch fabric. The at least one other node, based on the broadcasted data packet, is to initiate a timer, the timer based on a time for a switch fabric manager for the switch fabric to indicate validity of the reset request to the at least one other node. The at least one other node to reset to the default state if the timer expires before another data packet is received from the switch fabric manager. The other data packet received from the switch fabric manager and including content to indicate the reset request is invalid.

### BACKGROUND

In networking environments such as those used in telecommunication and/or data centers, a switch fabric is utilized to rapidly move data between nodes (e.g., endpoints, switches, modules, blades, boards, etc.) coupled to the switch fabric. Typically a switch fabric provides a communication medium that includes numerous point-to-point communication links between the nodes coupled to the switch fabric. The switch fabric and the nodes coupled to it may operate in compliance with industry standards and/or proprietary specifications. One example of an industry standard is the Advanced Switching Interconnect Core Architecture Specification, Rev. 1.1, published November 2004, (“the ASI standard”).

Typically a switch fabric includes a switch fabric management architecture to maintain a robust communication medium and to facilitate the movement of data and/or instruction between the nodes coupled to the switch fabric. One part of the fabric management architecture is to manage/control the configuration of a node coupled to the edge of the switch fabric (e.g. an endpoint) or a node coupled within the switch fabric (e.g., a switch). As part of a typical fabric management architecture, a primary and a secondary fabric manager manage/control at least a portion of each node's switch fabric configuration.

In one example, primary and secondary fabric managers are selected/elected from nodes coupled to the edge of a switch fabric. Once elected, each fabric manager then gains ownership of a spanning tree (ST) path coupled to the nodes. The ST path may be maintained in a memory accessible by the node and it includes a particular route or path through which owning fabric managers forward management/control instructions to node's coupled to the switch fabric. Ownership may grant the fabric managers privileged access to the nodes to configure the nodes to operate on the switch fabric. Thus, a node receiving a configuration request (e.g., reset to a default state) ignores the request if the request was not routed via the ST path associated with the owning fabric manager.

### BRIEF DESCRIPTION OF THE DRAWINGS

FIG. 1A is an illustration of elements of an example switch fabric with ST paths;

FIG. 1B is an illustration of elements of the example switch fabric with ST paths following a reset to a default configuration;

FIG. 2 is a block diagram of an example reset manager architecture;

FIG. 3 is an example data packet format to request a reset; and

FIG. 4 is a flow chart of an example method to reset devices on the switch fabric.

### DETAILED DESCRIPTION

As mentioned in the background, a node on a switch fabric may grant privileged access to its switch fabric configuration to a primary or secondary fabric manager that owns an ST path to the node. Although this disclosure is not limited to switch fabrics that include both a primary and a secondary fabric manager but may include switch fabrics having one or a multitude of fabric managers. In one example where a primary and a secondary fabric manager own ST paths, an ST path is broken when a node (e.g., a switch) coupled between an owned node and the primary fabric manager is removed or fails. In this instance, the primary fabric manager no longer has privileged access to configure the node. Thus, the primary fabric manager sends a reset request through the secondary fabric manager in order to reset the node to a default state. However, if the ST path owned by the secondary fabric manager is also broken, then the primary fabric manager has no ST path through which to route a request to reset. This may require the entire switch fabric to be manually shutdown and then restarted to reset the node. Since a manual intervention is needed to reconfigure a broken ST path, it is problematic to the automated management of a switch fabric.

In one example, a node on a switch fabric may generate a reset request, even if the node is not a primary or secondary fabric manager. The node may generate the reset request after recognizing that the ST paths to the primary and secondary fabric managers are broken and then broadcast the request to other nodes coupled to the switch fabric. The other nodes based on the data packet may initiate a timer. The timer may be based on the amount of time for a fabric manager to validate the node's reset request and then to send a message to the other nodes to reject the reset request if the node's reset request is found to be invalid (e.g., is not from a node recognized as part of the switch fabric and/or the ST path). If the other nodes fail to receive an invalidity indication before the timer expires, the other nodes may then reset to a default state. In one example, once in a default state, a node may reestablish an ST path with one or more fabric managers on the switch fabric.

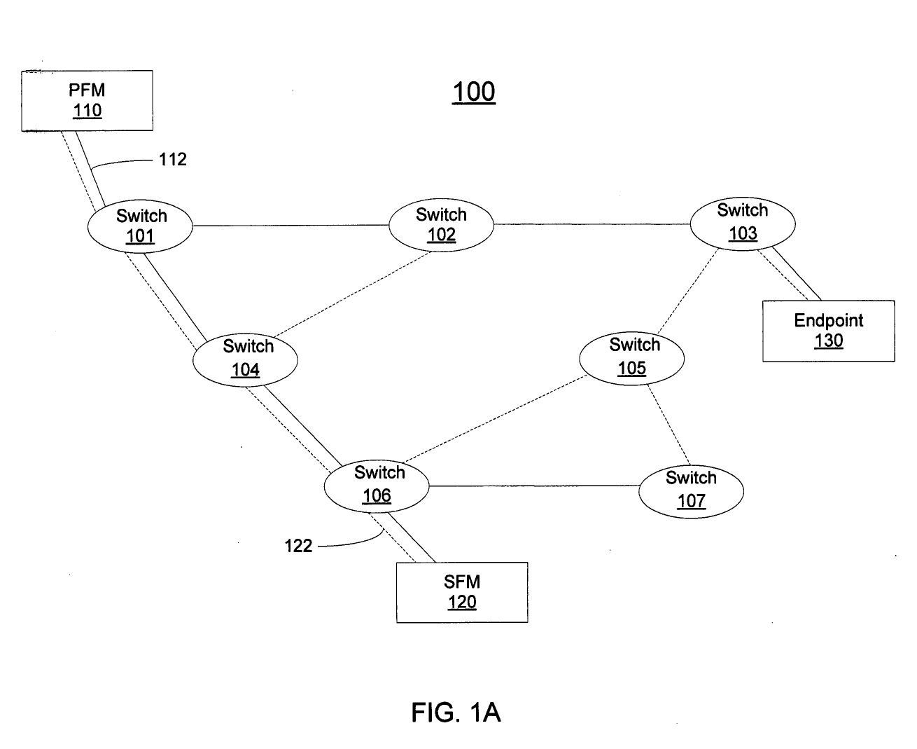

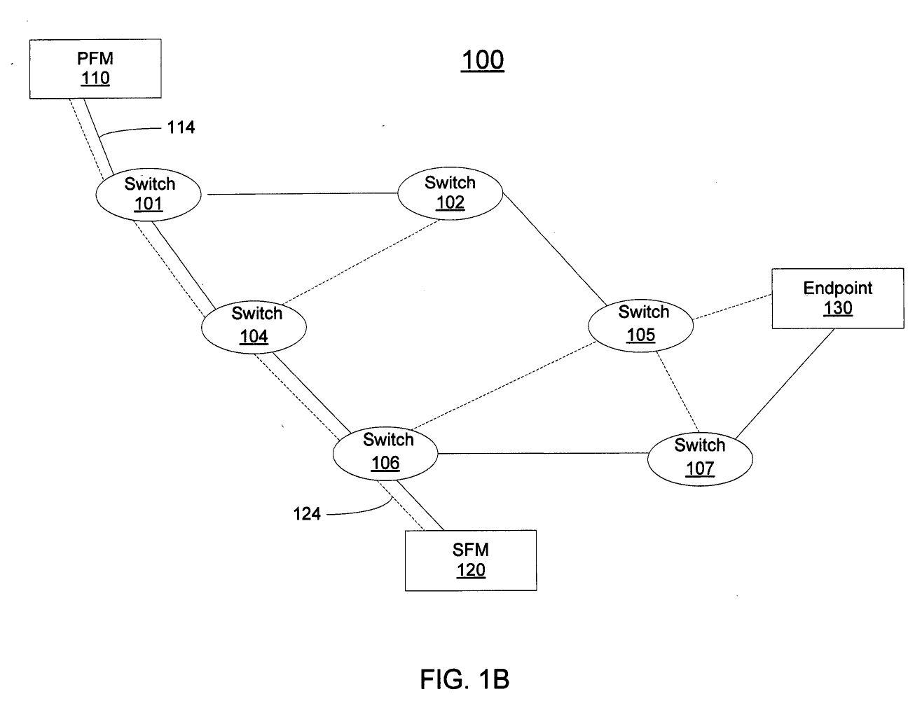

FIG. 1A is an illustration of elements of switch fabric 100. As depicted in FIG. 1A, switch fabric 100 includes switches 101-107, a primary fabric manager (PFM) 110, a secondary fabric manager (SFM) 120 and an endpoint 130. In one example, each of these nodes are coupled to switch fabric 100 with PFM 110, SFM 120 and endpoint 130 being coupled on the edge of switch fabric 100 and switches 101-107 being coupled within switch fabric 100.

In one example, switch fabric 100 is operated in compliance with the ASI standard. In this example, ASI compliant switch fabric 100 has completed the election of PFM 110 and SFM 120 to manage/control switch fabric 100. As shown by the lines connecting each of the nodes in switch fabric 100, solid lined ST path 112 is owned by PFM 110 and dash lined ST path 122 is owned by SFM 120. As introduced above, ownership of an ST path grants a fabric manager privileged access to configure how the nodes operate on and/or couple to a switch fabric. Thus, PFM 110 has privileged access to the configuration of switches 101-107, endpoint 130 as well as SFM 120 through ST path 112. SFM 120 has privileged access to the configuration of the same nodes, as well as PFM 110 through ST path 122.

In one example, switch 103 is removed and/or fails in ASI compliant switch fabric 100. This failure breaks both ST paths 112 and 122 to endpoint 130. As a result, endpoint 130 has no path from which PFM 110 or SFM 120 can request a reset to a default state to reestablish ST paths to endpoint 130. Thus, PFM 110 or SFM 120 no longer has privileged access to endpoint 130's switch fabric configuration. Should the configuration of the switch fabric need to be changed for various run-time activities, (e.g., a reconfiguration of routes for data forwarded across the switch fabric) endpoint 130's switch fabric configuration cannot be changed without a manual reset. This may result in endpoint 130's isolation from any configuration changes on the fabric until a manual reset is initiated.

As described in more detail below, in one example, a node in switch fabric 100 has the ability to generate a reset request and broadcast that reset request (e.g., via contents in a data packet) to at least one node coupled to switch fabric 100. Thus, in the example above, endpoint 130 may generate the reset request after recognizing that ST paths 112 and 122 are broken. Endpoint 130 may then broadcast a reset request to switches 101, 102 and 104-107, PFM 110 and SFM 120 over switch fabric 100.

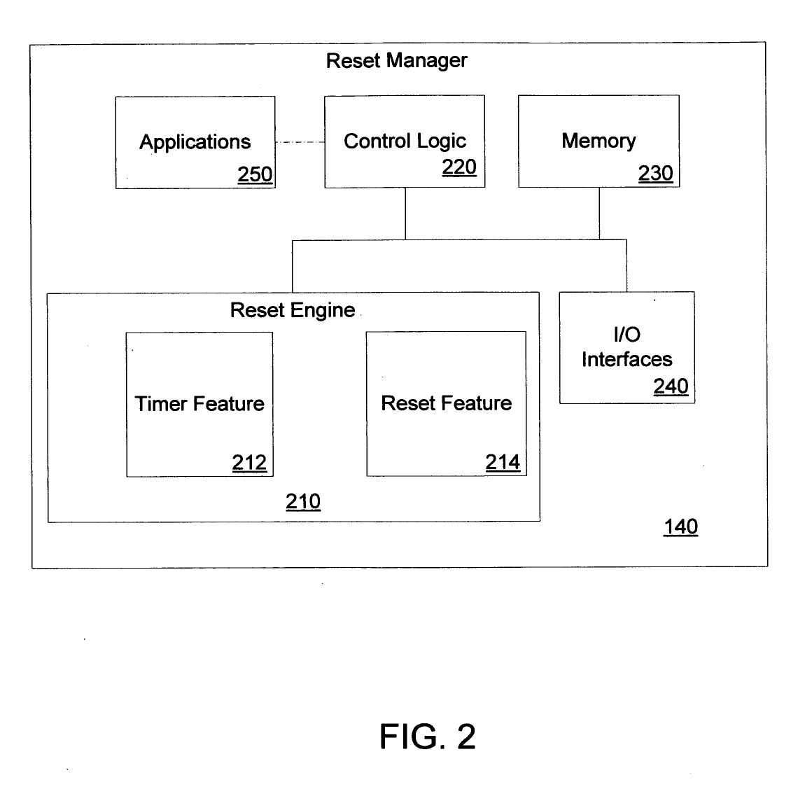

Although not shown in FIG. 1A, each node coupled to switch fabric 100 includes a reset manager 140 (described in FIG. 2). In one example, a reset manager 140 included in switch 102 may initiate a timer after switch 102 has received the reset request from endpoint 130. This timer may be based on the amount of time it takes for either PFM 110 or SFM 120 to verify or validate the reset request from endpoint 130 and to indicate to nodes coupled to switch fabric 100 via ST paths 112 and/or 122 the validity or invalidity of the reset request.

In one implementation, if the timer expires before receiving an indication that the reset request is invalid from either PFM 110 or SFM 120, then reset manager 140 may assume the request is valid and reset switch 102. In one example, switch 102 is reset to a default state. Reset managers 140 included in the other nodes may also initiate timers and then reset to a default state upon expiration of the timer. As a result, all nodes coupled to switch fabric 100 are reset to the default state based on a reset request generated by endpoint 130.

In one example, as depicted in FIG. 1B, beginning in the default state, the nodes of switch fabric 100 go through an initialization process (e.g., link synchronization, negotiate lane speed and width, etc.) and the process of electing a PFM and an SFM (e.g., PFM 110 and SFM 120). These fabric managers may then go through the process of owning the ST paths to the nodes in switch fabric 100 to account for the failure/removal of switch 103. Thus, FIG. 1B shows that PFM 110 owns solid lined ST paths 114 and SFM 120 owns dash lined ST path 124 to switches 101, 102, 104-107 and endpoint 130. In one example, this initialization, electing and owning process follows the processes described in the ASI standard.

FIG. 2 is a block diagram of an example reset manager 140 architecture. In FIG. 2, reset manager 140 includes a reset engine 210, control logic 220, memory 230, input/output (I/O) interfaces 240, and optionally one or more applications 250, each coupled as depicted.

In FIG. 2, reset engine 210 includes a timer feature 212 and a reset feature 214. In one implementation, these features initiate a timer based on a data packet received from another node requesting that a node reset to a default state and then reset the node to a default state if the timer expires before the node receives an indication from a fabric manager that the request from the other node is invalid.

Control logic 220 may control the overall operation of reset manager 140 and represents any of a wide variety of logic device(s) and/or executable content to implement the control of reset manager 140. In this regard, control logic 220 may include a microprocessor, network processor, microcontroller, field programmable gate array (FPGA), application specific integrated chip (ASIC), or executable content to implement such control features, and/or any combination thereof In alternate examples, the features and functionality of control logic 220 may be implemented within reset engine 210.

According to one example, memory 230 is used by reset engine 210 to temporarily store information. For example, information related to determining the amount of time to set a timer. Memory 230 may also store executable content. The executable content may be used by control logic 220 to implement the features of count engine 210.

I/O interfaces 240 may provide a communications interface to reset manager 140. For example, I/O interfaces 240 may provide a communications interface between reset manager 140 and an electronic system via a communication medium or link. As a result, via I/O interfaces 240, control logic 220 can receive a series of instructions from application software external to reset manager 140 and/or the node that includes reset manager 140. The series of instructions may cause control logic 220 to implement one or more features of reset engine 210.

In one example, reset manager 140 includes one or more applications 250 to provide internal instructions to control logic 220. Such applications 250 may be activated to generate a user interface, e.g., a graphical user interface (GUI), to enable administrative features, and the like. In alternate examples, one or more features of reset engine 210 may be implemented as an application 250, selectively activated by control logic 220 to initiate such features.

In one implementation, endpoint 130 in switch fabric 100 may generate a data packet including content to indicate a reset request to reset the nodes coupled to switch fabric 100 to a default state. Endpoint 130 may broadcast this data packet to at least one node coupled to switch fabric 100. For example, switch 102 may receive the data packet indicating a reset request. Upon and/or after receipt of the data packet, reset engine 210 may activate timer feature 212 to initiate a timer. Reset engine 210 may then activate reset feature 214 to reset switch 102 to a default state if the timer expires before the switch 102 receives an indication from PFM 110 or SFM 120 that the reset request is invalid.

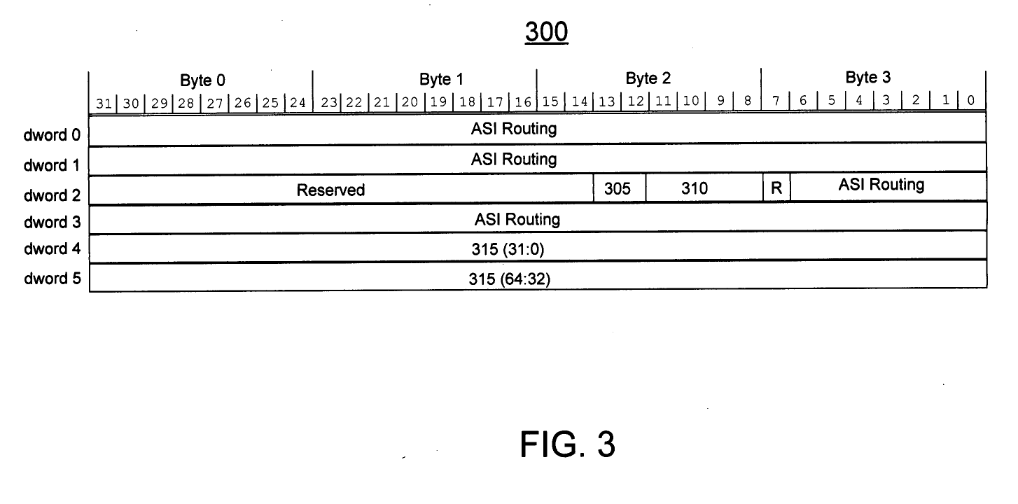

FIG. 3 is an example packet format 300 to request a reset. In one implementation, packet format 300 is used by a node in an ASI compliant switch fabric 100 to broadcast a reset request to at least one other node coupled to switch fabric 100. In this implementation, packet format 300 is similar to the packet format of a protocol interface-0 (PI-0) ST path building data packet referred to in the ASI standard as a “PI-0:0 packet.” The fields in double words (dwords) 0, 1 and 3 relate to ASI specific routing content as well as the field in bits 0-6 of dword 2. In addition, the fields in bits 14-31 and bit 7 in dword 2 are reserved.

In one implementation, packet format 300 includes field 305 in bits 12-13 of dword 2. field 305 may include content to indicate an ST reset request if a data packet in the format of packet 300 is generated by a non-fabric manager node. Field 305 may also include content to indicate a rejection of a reset request if a data packet in the format of packet format 300 is generated by a fabric manager node.

In one example, packet format 300 includes a field 310 in bits 8-11 of dword 2. Field 310 may include content to indicate the ST path associated with the reset request data packet or the reject reset data packet. In dwords 4 and 5, packet format 300 includes a 64-bit field 315. In one example, a given 64-bit Extended Unique Identifier (EUI) is associated with each node coupled to a switch fabric. Thus, content indicating the 64-bit EUI may be inserted in field 315 to indicate the source of the reset request.

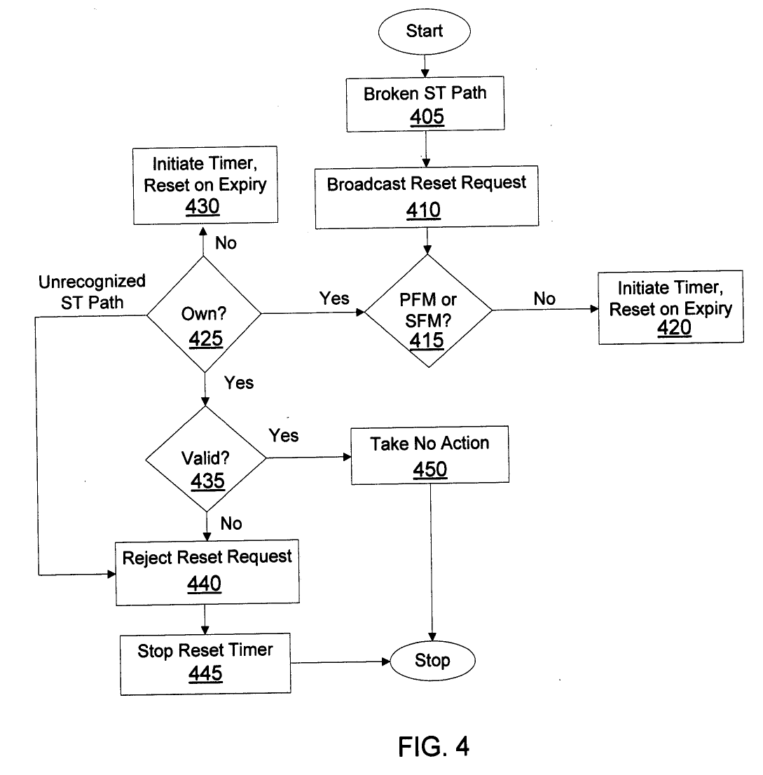

FIG. 4 is a flow chart of an example method to reset nodes on switch fabric 100. In this example method, switch fabric 100 operates in compliance with the ASI standard. However, this disclosure is not limited to only ASI compliant switch fabrics but may also apply to other switch fabric standards and/or propriety switch fabric specifications.

In block 405, according to one example, switch 103 fails and/or is removed from switch fabric 100. Since both ST paths 112 and 122 (see FIG. 1A) are broken, no fabric manager has privileged access to configure endpoint 130 to operate on switch fabric 100. Endpoint 130 may recognize that the paths are broken when it receives one or more requests to change its switch fabric configuration routed via ST paths that don't match the paths established when ST paths 112 and 122 were owned by PFM 110 and SFM 120, respectively. For example, as shown in FIG. 1A, ST path 112 from PFM 110 to endpoint 130 is PFM 110=>switch 101=>switch 102=>switch 103=>endpoint 130 and ST path 122 from SFM 120 to endpoint 130 is SFM 120=>switch 106=>switch 105=>switch 103=>endpoint 130. Thus, if endpoint 130 receives one or more configuration requests from PFM 110 or SFM 120 that does not match these ST paths it may determine that the ST paths are broken.

In block 410, endpoint 130 generates a data packet in the format of packet format 300 including content in field 305 to indicate a reset request and to include content in field 310 to indicate which ST path the reset request is associated with (e.g., ST path 112). Endpoint 130 also places its 64-bit EUI in field 315 to identify endpoint 130 as the source of the reset request. The data packet in the format of data packet format 300 is then forwarded to the nodes coupled to switch fabric 100 to broadcast the reset request.

In one example, after broadcasting the reset request, endpoint 130's reset manager 140 may activate timer feature 212 to initiate a timer. In one example, timer feature 212 may initiate the timer to expire based on the amount of time it takes for a fabric manager to validate or invalidate the reset request and communicate that back to nodes coupled to switch fabric 100. For example, 2× the maximum time a data packet can take to traverse switch fabric 100. This may assume that it takes X time for a broadcasted reset request to traverse switch fabric 100 and reach PFM 110 or SFM 120. This also may assume that it will take X time for the reject request data packet to start from PFM 110 or SFM 120 and traverse back to the source of the reset request. In this example, the source is endpoint 130.

Once the timer is initiated by timer feature 212, reset engine 210 activates reset feature 214. Reset feature 214 monitors the timer. In one example, no indication is received from PFM 110 or SFM 120 to reject the request before the timer expires. Thus, reset feature 214 resets endpoint 130 to the default state.

In block 415, the data packet broadcast by endpoint 130 is received by a node on switch fabric 100. If the node is not a PFM or SFM then the process moves to block 420. If the node is a PFM or SFM the process moves to block 425.

In block 420, each non-fabric manager node reads at least a portion of the data packet in the format of packet format 300 to authenticate the source of the message (e.g., recognizing endpoint 130's 64-bit EUI in field 315 or using other methods of authentication). The non-fabric manager node may then activate timer feature 212 to initiate a timer. Once the timer is initiated, reset feature 214 is activated to monitor the timer and to monitor for any indication to reject the reset request. As described above in block 410, reset feature 212 may reset the node based on the results of the monitoring.

In one example, a non-fabric manager node upon receipt of a reset request, may verify that there is not already a timer running based on a previous reset request from endpoint 130. If there is a timer running, the node will ignore the subsequent reset request. If no timer is running, then the node will initiate the timer as described above and may then forward the reset request on all ports or links coupling the node to switch fabric 100 (with the exception of the port by which the reset request was received).

In block 425, a node receiving the reset request data packet in the format of packet format 300 is a fabric manager (e.g., PFM 110). In one example, PFM 110 may read the contents of field 310 to determine if the reset request is associated with the ST path it owns (ST path 112). If field 310 does not include content to indicate ST path 112 then the process moves to block 430. If field 310 includes content to indicate ST path 112 then the process moves to block 435.

In one example, PFM 110 may also determine whether the reset request data packet is associated with any ST path for switch fabric 100. As depicted in FIG. 1A, switch fabric 100 includes ST paths 112 and 122. For example, PFM 112 may be aware of the ST paths owned by not only itself but by other fabric managers for switch fabric 100 (e.g., SFM 120). Thus, if the reset request data packet does not include content to indicate either ST path 112 or 122 the process moves to block 440.

In block 430, in one example, PFM 110's reset manager 140 goes through the same process described for non-fabric manager nodes in block 420. The only exception is that PFM 110 may receive a reject reset request data packet only from SFM 112.

In block 435, PFM 110 may read the contents of field 315 to determine whether the request originated from a node that is coupled to an ST path 112. In one implementation, PFM 110 may access a table stored in a memory assessable to PFM 110. The table may include the 64-bit EUIs for all nodes owned through ST path 112. PFM 110 may compare the 64-bit content in field 315 to the EUI values in the table. If the 64-bit content in EUI field 315 is not in the table, the process moves to block 440. If it is in the table, the process moves to block 450.

In block 440, PFM 110 determines that the reset request is not valid. In one implementation, PFM 110 then generates a data packet in the format of packet format 300 to indicate to the nodes on switch fabric 100 to reject the reset request. In one implementation, PFM 110 includes content in field 305 to indicate a rejection of the reset request. PFM 110 may also include content to indicate the source node of the request in field 315. In this example, the source is endpoint 130.

In block 445, each node's reset feature 214 may stop and/or reset the timer initiated by timer feature 212 after receipt of the data packet including content to indicate the reset request from endpoint 130 was invalid. Thus, the nodes coupled to switch fabric 100 will not reset to a default state. The process then stops until another reset request is initiated by another node coupled to switch fabric 100.

In block 450, the 64-bit EUI content in field 315 is in the table. Therefore, PFM 10 determines that the reset request is valid and takes no action. As a result, all timers initiated by each node's reset manger 140 will expire and the nodes coupled to switch fabric 100 will reset to a default state. The process then stops until another reset request is initiated by another node coupled to switch fabric 100.

Referring again to memory 230 in FIG. 2. Memory 230 may include a wide variety of memory media including but not limited to volatile memory, non-volatile memory, flash, programmable variables or states, random access memory (RAM), read-only memory (ROM), flash, or other static or dynamic storage media. In one example, machine-readable instructions can be provided to memory 230 from a form of machine-accessible medium. A machine-accessible medium may represent any mechanism that provides (i.e., stores and/or transmits) information in a form readable by a machine (e.g., switches 101-107, endpoint 130, PFM 110, SFM 120, reset manager 140). For example, a machine-accessible medium may include: ROM; RAM; magnetic disk storage media; optical storage media; flash memory devices; electrical, optical, acoustical or other form of propagated signals (e.g., carrier waves, infrared signals, digital signals); and the like.

In the previous descriptions, for the purpose of explanation, numerous specific details were set forth in order to provide an understanding of this disclosure. It will be apparent that the disclosure can be practiced without these specific details. In other instances, structures and devices were shown in block diagram form in order to avoid obscuring the disclosure.

References made in the specification to the term “responsive to” are not limited to responsiveness to only a particular feature and/or structure. A feature may also be “responsive to” another feature and/or structure and also be located within that feature and/or structure. Additionally, the term “responsive to” may also be synonymous with other terms such as “communicatively coupled to” or “operatively coupled to,” although the term is not limited in his regard.

What is claimed is:

1. In a node coupled to a switch fabric, a method comprising:
generating a data packet including content to indicate a reset request to reset a node coupled to the switch fabric to a default state; and
broadcasting the data packet to at least one other node coupled to the switch fabric, wherein based on the data packet the at least one other node is to:
initiate a timer, the timer based on a time for a switch fabric manager for the switch fabric to indicate validity of the reset request to the at least one other node; and
reset to the default state if the timer expires before another data packet is received from the switch fabric manager, the other data packet including content to indicate the reset request is invalid.

2. A method according to claim 1, wherein the at least one other node includes a switch, the switch to forward the data packet after initiating the timer, the data packet forwarded to a node other than the node that generated the reset request.

3. A method according to claim 1, further comprising:
the node generating the reset request based on an indication that a spanning tree path associated with the switch fabric manager is broken, the spanning tree path to enable the switch fabric manager to route management instructions to manage the node's switch fabric configuration.

4. A method according to claim 3, wherein the node reestablishes another spanning tree path associated with the switch fabric manager based on nodes coupled to the switch fabric resetting to the default state.

5. A method according to claim 3, wherein the indication that the spanning tree path is broken is determined based on the node receiving a configuration request from the switch fabric manager via a route that does not match the spanning tree path associated with the switch fabric manager.

6. A method according to claim 3, wherein the switch fabric manager to indicate the reset request is invalid comprises the switch fabric manager to receive the data packet including content to indicate a reset request and then to determine whether the node making the reset request is among at least one node through which management instructions are routed on the s spanning tree path, wherein the reset request is invalid if the node is not among the at least one node through which management instructions are routed.

7. A method according to claim 4, wherein the switch fabric is operated in compliance with the Advanced Switching Interconnect Standard.

8. A method according to claim 7, wherein after the nodes coupled to the switch fabric reset to the default state, but prior to the nodes reestablishing the spanning tree path associated with the fabric manager, the nodes perform an initialization process that includes synchronizing communication links between each node and negotiating lane speeds and widths on the communication links between each node.

9. An apparatus comprising:
a reset manager to initiate a timer based on a data packet received at a node coupled to a switch fabric, the data packet including content to indicate a reset request to reset the node to a default state, the timer based on a time for a switch fabric manager to indicate validity of the reset request, wherein the reset manager resets the node to the default state if the timer expires before the node receives an indication from the switch fabric manager that the reset request is invalid.

10. An apparatus according to claim 9, wherein the node receives an indication from the switch fabric manager that the reset request is invalid via receipt of another data packet from the switch fabric manager, the other data packet to include content to indicate the reset request is invalid.

11. An apparatus according to claim 9, wherein the node is a switch.

12. An apparatus according to claim 9, wherein the node is a secondary switch fabric manager and the switch fabric manager to indicate whether the request is valid is the primary switch fabric manager.

13. An apparatus according to claim 9, wherein the reset request is based on an indication that a spanning tree path associated with the switch fabric manager is broken between the node making the request and the switch fabric manager, the spanning tree path to enable the switch fabric manager to route management instructions to manage the request making node's switch fabric configuration.

14. An apparatus according to claim 13, wherein the switch fabric is operated in compliance with the Advanced Switching Interconnect standard.

15. An apparatus according to claim 9, the apparatus further comprising:
a memory to store executable content; and
a control logic, communicatively coupled with the memory, to execute the executable content to implement the reset manager.

16. A switch fabric comprising:
a switch fabric manager;
a node to generate and broadcast a data packet including content to indicate a reset request to reset at least one node coupled to the switch fabric; and
another node, the other node including a reset manager to initiate a timer based on the data packet broadcasted from the node, the timer based on a time for the switch fabric manager to indicate validity of the reset request, wherein the reset manager resets the other node to the default state if the timer expires before the other node receives an indication from the switch fabric manager that the reset request is invalid.

17. A switch fabric according to claim 16, wherein the other node receives an indication from the switch fabric manager that the reset request is invalid via receipt of another data packet from the switch fabric manager, the other data packet to include content to indicate the reset request is invalid.

18. A switch fabric according to claim 16, wherein the other node is a secondary switch fabric manager and the switch fabric manager is the primary switch fabric manager.

19. A switch fabric according to claim 16, wherein the reset request is based on an indication that a spanning tree path associated with the switch fabric manager is broken between the node and the switch fabric manager, the spanning tree path to enable the switch fabric manager to route management instructions to manage the node's switch fabric configuration.

20. A switch fabric according to claim 16, wherein the switch fabric is operated in compliance with the Advanced Switching Interconnect standard.

21. A machine-accessible medium comprising content, which, when executed by a node causes the node to:
generate a data packet including content to indicate a reset request to reset a node coupled to the switch fabric to a default state; and
broadcast the data packet to at least one other node coupled to the switch fabric, wherein based on the data packet the at least one other node is to:
initiate a timer, the timer based on a time for a switch fabric manager for the switch fabric to indicate validity of the reset request to the at least one other node; and
reset to the default state if the timer expires before another data packet is received from the switch fabric manager, the other data packet including content to indicate the reset request is invalid.

22. A machine-accessible medium according to claim 21, further comprising:
the node to generate the reset request based on an indication that a spanning tree path associated with the switch fabric manager is broken, the spanning tree path to enable the switch fabric manager to route management instructions to manage the node's switch fabric configuration.

23. A machine-accessible medium according to claim 22, wherein the node is to reestablish another spanning tree path associated with the switch fabric manager based on nodes coupled to the switch fabric resetting to the default state.

24. A machine-accessible medium according to claim 22, wherein the indication that the spanning tree path is broken is determined based on the node receiving a configuration request from the switch fabric manager that does not match the spanning tree path associated with the switch fabric manager.

25. A machine-accessible medium according to claim 22, wherein the switch fabric manager to indicate the reset request is invalid comprises the switch fabric manager to receive the data packet including content to indicate a reset request and then to determine whether the node making the request is among at least one node through which management instructions are routed on the spanning tree path, wherein the reset request is invalid if the node is not among the at least one node through which management instructions are routed.
